(19) United States
(12) Patent Application Publication
(10) Pub. No.: US 2005/0074280 A1
(43) Pub. Date: Apr. 7, 2005

(54) Connecting mechanism and apparatus using the same

(76) Inventor: Yi-Jen Chen, Luzhou City (TW)

Correspondence Address: BIRCH STEWART KOLASCH & BIRCH, PO BOX 747, FALLS CHURCH, VA, 22040-0747, US

(21) Appl. No.: 10/945,918

(22) Filed: Sep. 22, 2004

(30) Foreign Application Priority Data
Oct. 3, 2003 (TW) 092127400

(51) Int. Cl. H01R 11/22

(52) U.S. Cl. 403/329

(57) ABSTRACT

An easily-assembled connecting mechanism and the apparatus using the same. The apparatus comprises a first and second pieces. The connecting mechanism includes a hook member and a holding member. The hook member has a head portion and a lever portion connected to the first piece; The extendable receptacle member has a plurality of cantilevered arms disposed around a through hole of the second piece. Each cantilevered arm of the extendable receptacle member has a holding portion to fix the head portion of the hook member and an inner tapered surface forming a cone. During joining of the first and second pieces, the cantilevered arms are elastically deformed, and the head of the hook member is pushed into and fixed by the holding portion of the holding member.

### BACKGROUND OF THE INVENTION

1. Field of the Invention

The present invention relates to a connecting mechanism, and in particular to a connecting mechanism not suing screws.

2. Description of the Related Art

Conventional assembly often presets screw holes or seats into which screws are mounted. This connecting mechanism, however, increases the number of elements required labor, thus increasing fabrication time and cost.

### SUMMARY OF THE INVENTION

Accordingly, an object of the invention is to provide a connecting mechanism combining two work pieces without use of screws, thus reducing costs.

Another object of the invention is to provide a connecting mechanism to simplify assembly steps and shorten fabrication time.

A third object of the invention is to provide a connecting mechanism without use of screws, such that a product with the connecting mechanism of the invention can be more easily assembled automatically.

The present invention provides a connecting mechanism for combining a first and second pieces. The connecting mechanism comprises a hook member disposed on the first piece and a extendable receptacle member disposed on the second piece. The hook member has a head portion and a lever portion connected to the first piece. The width of the head portion exceeds that of the lever portion. The extendable receptacle member includes a plurality of cantilevered arms disposed around a first opening of the second piece. Each cantilevered arm has an inner surface and a holding portion. During joining the first and second pieces, the cantilevered arms are compressed and elastically deformed by the head portion of the hook member, such that the head portion is fixed by the holding portions of the cantilevered arms.

In a preferred embodiment, the inner surface of each cantilevered arm comprises at least one ramp surface, together defining a tapered cavity with a bottom close to the first opening. When an releasing tool is inserted into the tapered cavity, contacting the ramp surfaces of the cantilevered arms, the cantilevered arms are separated, releasing the head portion of the hook member.

The bottom portion of the tapered cavity comprises the largest cross section, with tapered cavity conical or pyramidal. The head portion is conical, pyramidal or hemispherical. The lever portion is cylindrical or polygonal. In addition, the head portion has a recess. The holding portion of each cantilevered arm is a through hole. The extendable receptacle member is substantially cylindrical and the cantilevered arms are semi-cylindrical.

The present invention also provides an apparatus comprising a first piece, second piece and the connecting mechanism described. The hook member is integrally formed on the first piece, and the cantilevered arms of the extendable receptacle member on the second piece around the first opening. When combining the first and second pieces, the hook member is simply pressed into the holding member, the head portion thereof fixed by the holding portions of the cantilevered arm cantilevered arms. Furthermore, when a means is inserted into the tapered cavity through the first opening of the second piece, compressing the ramp surfaces of the cantilevered arms, the cantilevered arm cantilevered arms are easily separated, releasing the head portion of the hook member.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings which are given by way of illustration only, and thus are not limitation of the present invention, and wherein:

FIG. 1 is an exploded view of the connecting mechanism of the invention;

FIGS. 2A˜2D are cross sections of the connecting mechanism during assembly.

FIGS. 3A˜3D are cross sections of the connecting mechanism during disassembly; and

FIGS. 4A˜4B are cross sections of the hook members in other preferred embodiments of the invention.

### DETAILED DESCRIPTION OF THE INVENTION

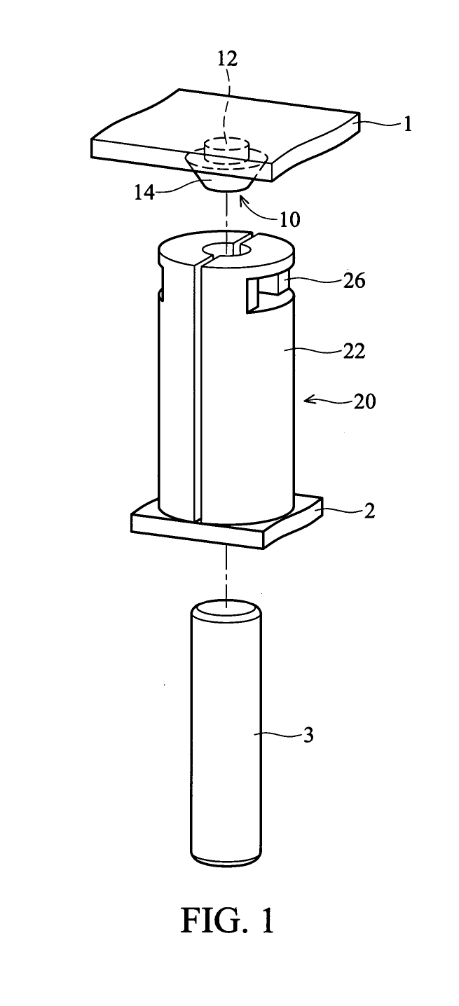

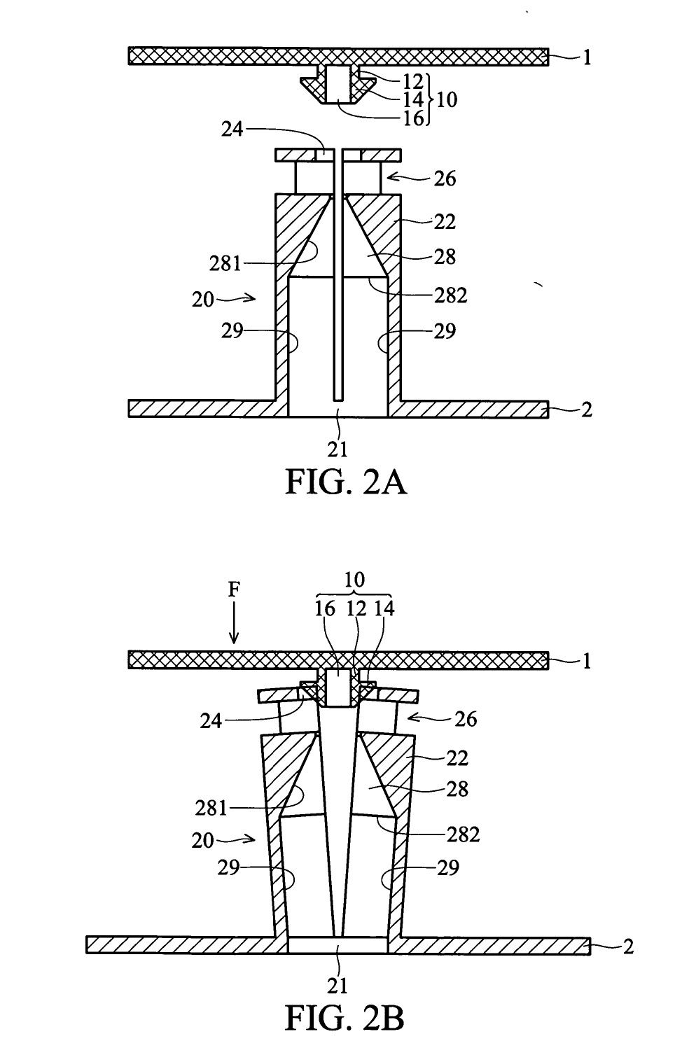

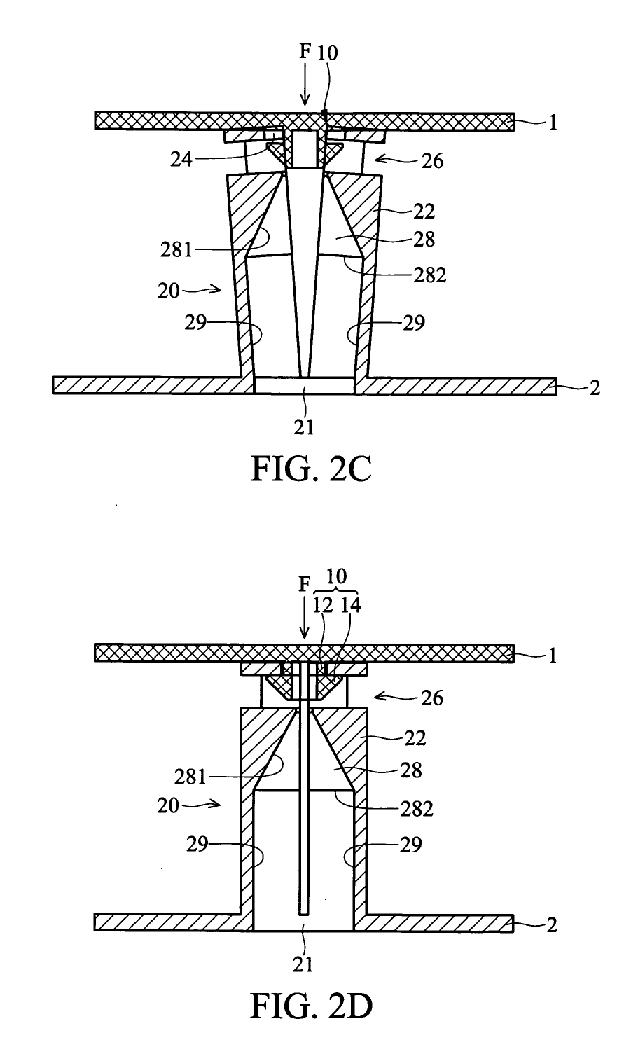

FIG. 1 is an exploded view of the connecting mechanism of the invention. FIG. 2A is a cross section thereof. In FIGS. 1 and 2A, a first and second pieces 1, 2 comprises easily-assembled connecting mechanisms 10, 20 respectively. The connecting mechanism comprises a hook member 10 and a extendable receptacle member 20. The hook member 10 includes a head portion 14 and a lever portion 12 connected to the first piece 1. The width of the head portion 14 exceeds that of the lever portion 12. In this embodiment, the head portion 14 of the hook member 10 is conical and has a recess 16 passing through the head and lever portion 14, 12, preventing shrinking of the hook member 10 during injection molding.

The extendable receptacle member 20 is integrally formed on the second piece 2, of ABS, PC or other plastic material, by injection molding. In this embodiment, the extendable receptacle member 20 is substantially cylindrical and comprises two semi-cylindrical cantilevered arm cantilevered arms 22 disposed around a opening 21. In FIG. 2A, the extendable receptacle member 20 is hollow, and each cantilevered arm 22 thereof has a holding portion 26 and a curved inner surface 29. The holding portions 26 are through holes horizontally passing through the cantilevered arms 22, engaging the head portion 14 of the hook member 10. The inner surface 29 of each cantilevered arm 22 has at least one ramp surface 281 or a curved surface. Ramp surfaces 281 together define a tapered cavity 28, such as a conical or pyramidal cavity, with a bottom 282 close to the opening 21. The bottom 282 of the tapered cavity 28 has the largest cross section, such that when an releasing tool, or a cylinder 3 in FIG. 1, is inserted into the tapered cavity 28 through the opening 21 of the first piece 1, compressing the ramp surfaces 281 of the cantilevered arms 22, the cantilevered arms 22 of the extendable receptacle member 20 are separated, releasing the head portion 14 of the hook member 10.

FIGS. 2A˜2D are cross sections of the connecting mechanism during assembly. In FIG. 1 and 2A, the cantilevered arms 22 of the extendable receptacle member 20 have notches in the top portions, forming an opening 24. When combining the first and second pieces 1, 2 of the apparatus, the hook member 10 is aligned with the opening 24 and pressed onto the top surface of the extendable receptacle member 20, separating the cantilevered arms 22, which are elastically deformed as shown in FIG. 2B. In FIGS. 2C and 2D, when the widest part of the head portion 14 passes through the opening 24, the cantilevered arms 22 return to their original positions and the holding portions 26 of the cantilevered arms 22 engage the head portion 14 of the hook member 10, thus combining the first and second pieces 1, 2.

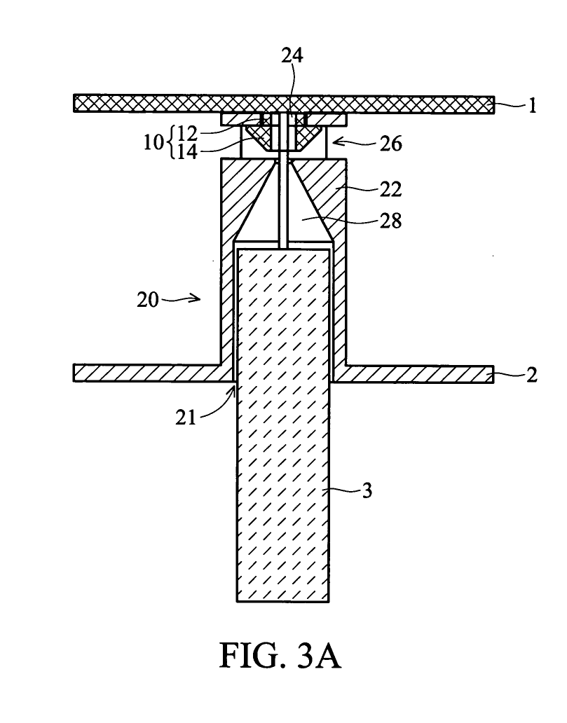

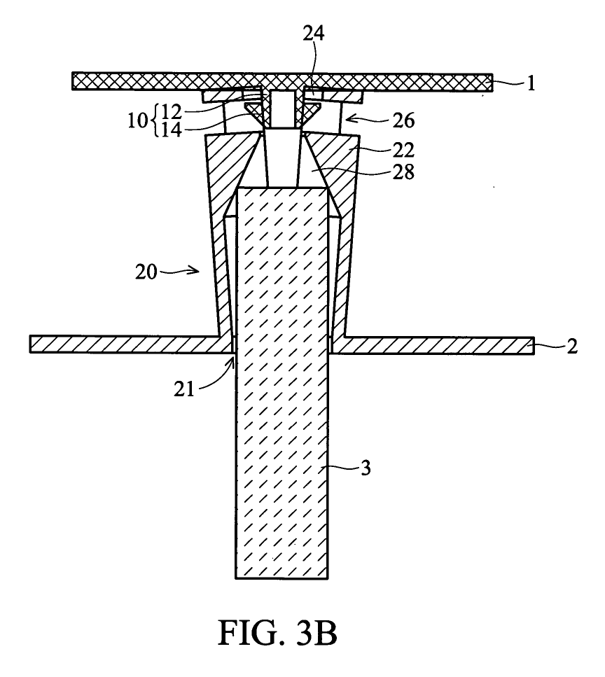

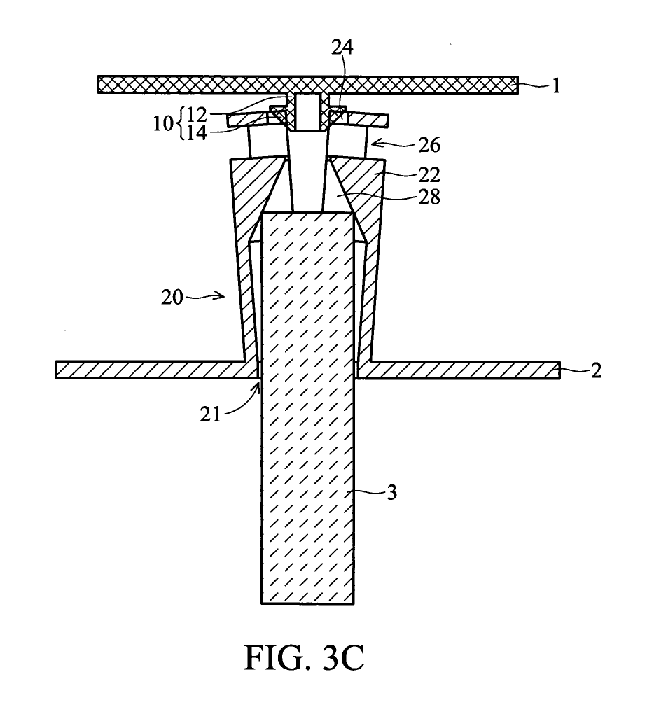

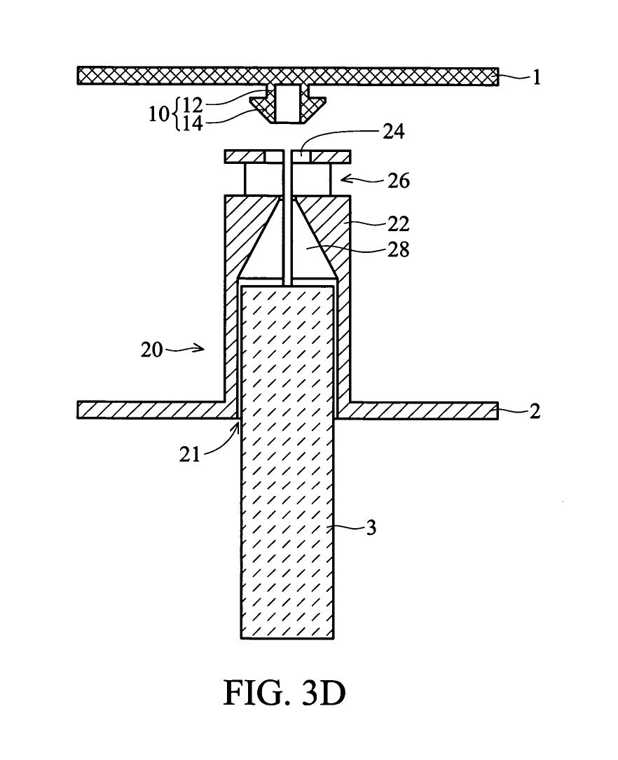

FIGS. 3A˜3D are cross sections of the connecting mechanism during disassembly. In FIGS. 3A˜3D, when disassembly of the first and second pieces 1, 2, a cylinder 3 with smaller diameter is inserted into the hollow portion of the extendable receptacle member 20 through the opening 21 (FIG. 3A). After contacting the ramp surfaces of the tapered cavity, the cylinder 3 is slightly depressed to separate the cantilevered arms 22 as shown in FIG. 3B. When the opening 24 is larger than the widest part of the head portion 14, the hook member 10 is released from the extendable receptacle member 20 and the first and second pieces 1, 2 is separated as shown in FIGS. 3C and 3D.

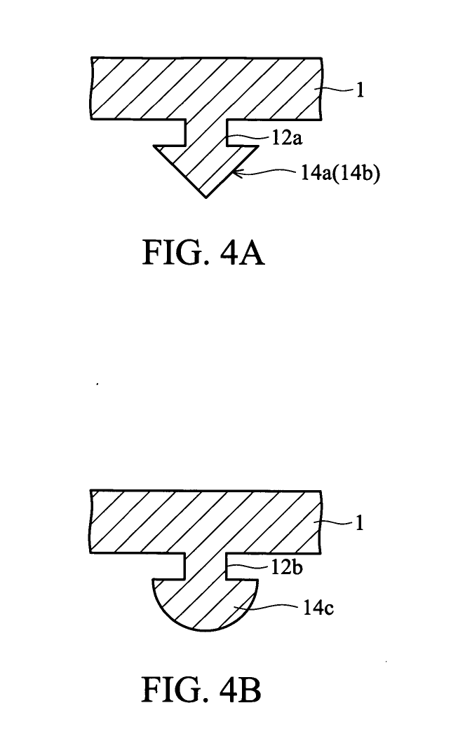

FIGS. 4A˜4B are cross sections of the hook members in other preferred embodiments of the invention. In FIGS. 4A and 4B, the lever portion of the hook member is a polygon 12a or cylinder 12b. The head portion of the hook member is, but is not limited to, a cone 14a, pyramid 14b or hemisphere 14c. The head portion is wider than the lever portion and the unextended diameter of the opening on the holding member.

In FIGS. 1 and 2A, the extendable receptacle member 20 of the connecting mechanism may have more than two cantilevered arms, such as four quarter-cylindrical cantilevered arms. In addition, the thickness of the cantilevered arms and the depth and width of the gaps between each two thereof can be simply modified according to the required strength of the cantilevered arms, preventing the cantilevered arms from breaking during assembly.

An apparatus with the connection mechanism of the invention can be assembled without tools and disassembled with only a cylinder, thus reducing assembly steps, fabrication time, components thereof and product cost.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art) Therefore, the scope of the appended claims should be accorded the broadest interpretation so as to encompass all such modifications and similar arrangements.

1. A connecting mechanism for quick locking a first piece and a second piece including a first opening, comprising:
a hook member having a head portion and a lever portion connected to the first piece, wherein the width of the head portion exceeds that of the lever portion; and
a extendable receptacle member including a plurality of cantilevered arms disposed around the first opening of the second piece, wherein each cantilevered arm has an inner surface and a holding portion, such that, upon insertion of the hook member thereinto, the cantilevered arms are elastically deformed and the head portion is secured by the holding portions of the cantilevered arms.

2. The connecting mechanism as claimed in claim 1, wherein the inner surface of each cantilevered arm has at least one ramp surface, and the ramp surfaces together form a tapered cavity with a bottom close to the first opening.

3. The connecting mechanism as claimed in claim 2, wherein when an releasing tool is inserted into the tapered cavity, compressing the ramp surfaces of the cantilevered arms, the cantilevered arms separate, releasing the head portion of the hook member.

4. The connecting mechanism as claimed in claim 2, wherein the bottom of the tapered cavity has the largest cross section.

5. The connecting mechanism as claimed in claim 2, wherein the tapered cavity is conical or pyramidal.

6. The connecting mechanism as claimed in claim 1, wherein the head portion is conical, pyramidal.

7. The connecting mechanism as claimed in claim 1, wherein the lever portion is cylindrical or polygonal.

8. The connecting mechanism as claimed in claim 1, wherein the head portion further comprises a recess, the hook member being inserted in lock situation.

9. The connecting mechanism as claimed in claim 1, wherein the holding portion of each cantilevered arm is a through hole.

10. The connecting mechanism as claimed in claim 1, wherein the cantilevered arms are arranged substantially in cylindrical pattern and the cantilevered arms are semi-cylindrical.

11. An apparatus, comprising:
a first piece;
a second piece having a first opening;
a hook member having a head portion and a lever portion connected to the first piece, wherein the width of the head portion exceeds that of the lever portion; and
a extendable receptacle member including a plurality of cantilevered arms disposed around the first opening of the second piece, wherein each cantilevered arm has an inner surface and a holding portion, when combining the first and second pieces, the cantilevered arms are elastically deformed and the head portion is pushed into and by the holding portions of the cantilevered arms.

12. The apparatus as claimed in claim 11, wherein the inner surface of each cantilevered arm has at least one ramp surface, and the ramp surfaces form a tapered cavity with a bottom close to the first opening.

13. The apparatus as claimed in claim 12, wherein when an release means is inserted into the tapered cavity, compressing the ramp surface of the cantilevered arms, the cantilevered arms separate, releasing the head portion of the hook member fasterner.

14. The apparatus as claimed in claim 12, wherein the bottom of the tapered cavity has the largest cross section.

15. The apparatus as claimed in claim 12, wherein the tapered cavity is conical or pyramidal.

16. The apparatus as claimed in claim 11, wherein the head portion is conical, pyramidal or hemispherical.

17. The apparatus as claimed in claim 11, wherein the lever portion is cylindrical or polygonal.

18. The apparatus as claimed in claim 11, wherein the head portion has a recess.

19. The apparatus as claimed in claim 11, wherein the holding portion of each cantilevered arm is a through hole.

20. The apparatus as claimed in claim 11, wherein the extendable receptacle member is substantially cylindrical and the cantilevered arms semi-cylindrical.
